(19) United States
(12) Patent Application Publication
(10) Pub. No.: US 2014/0059521 A1
(43) Pub. Date: Feb. 27, 2014

(54) Systems and Methods for Editing A Computer Application From Within A Runtime Environment

(71) Applicant: Robert Tyler Voliter, San Jose, CA (US)

(72) Inventor: Robert Tyler Voliter, San Jose, CA (US)

(73) Assignee: Adobe Systems Incorporated, San Jose, CA (US)

(21) Appl. No.: 12/350,416

(22) Filed: Jan. 8, 2009

(51) Int. Cl. G06F 9/44

(52) U.S. Cl. 717/125

(57) ABSTRACT

Embodiments allow a runtime environment to link to an editing environment. An object or other feature may be identified for editing in a runtime environment using a specific tool or gesture. Given an identified object, an appropriate source object and/or editing application may be identified and the editing application may be launched for editing the identified object or source object. Similarly, given an identified state, an editing application may be launched to provide the application for editing in the identified state. In some cases, after any editing of an application feature, the runtime environment receives and incorporates the edited feature. The user then sees the revised features in the runtime without having to re-launch and manually return to the specific application state, object, or other feature that was edited. The ability to edit the features of a running application provides various benefits and can facilitate testing of an application's features.

### FIELD

Embodiments relate generally to the field of computing and specifically to computing applications used to create, control, and otherwise display user interfaces, applications, and other computer content.

### BACKGROUND

Various software applications facilitate the creation of user interfaces, rich media applications, and other computer content. For example, Adobe® Flex® technologies can be used to create Adobe® Flash® content using an XML-based markup language commonly called MXML™ to declaratively build and lay out visual components. This declarative code can specify the visual attributes of the content, including the locations and display attributes of the content's visual components. The declarative code may be automatically generated based on a creator having graphically laid out components on a displayed creation canvas.

Developing content typically involves the use of one or more development and/or design applications, referred to herein generally as creation environments or creation applications. To run and test an application, the creator typically makes a change in the creation environment, saves, compiles, and executes the created application or other content. For example, to test interactivity, interactive applications must be edited, compiled, and run. When running the application the user navigates the user interface and encounters a problem with the visual design. With present creation applications, the user must exit the running application, go back to the creation application, and find and edit the object that corresponds to what the user saw during runtime. Finding the correct object can be difficult and time consuming. In addition, the user generally must then recompile, run the application, and return to where the object was wrong in order to validate the edit.

Among other deficiencies, existing techniques for testing applications fail to adequately facilitate this testing workflow. For example, break points provide a way of configuring a runtime application to stop execution when the point is encountered and return to the corresponding code associated with the break point, and can thus be useful in debugging and testing certain features of an application. Breakpoints, however, are inflexible in the sense that they must be set prior to running the application in a specific location or locations within the code, requiring knowledge of code to runtime feature relationships prior to setting the breakpoint. In addition, certain creation applications can identify frequently executed code that is potentially slowing down an application. Generally, existing testing features and tools provides certain advantages but are inflexible and inadequate with respect to correlating runtime features to the development features used to create the runtime features, particularly with respect to visually displayed assets. Thus, generally such tools fail to facilitate a workflow that involves a creator entering a runtime, recognizing a problem, and identifying an aspect of the application that needs to be edited and actually edited that aspect.

### SUMMARY

Certain embodiments allow a runtime environment to link to an editing environment. An object or other runtime feature may be identified for editing in a runtime environment using a specific tool or gesture. Given an identified object, an appropriate source object and/or editing application may be identified and the editing application may be launched for editing the identified object or source object. Similarly, given an identified state, an editing application may be launched to provide the application for editing in the identified state. In some cases, after any editing of an application feature, the runtime environment receives and incorporates the edited feature. The user then sees the revised features in the runtime without having to re-launch and manually return to the specific application state, object, or other feature that was edited. The ability to edit the features of a running application provides various benefits and can facilitate testing of an application's features.

One embodiment provides a method of editing an application's features from an environment in which the application is running. The method involves identifying a feature for editing, wherein the feature is a feature of a first application running in a first environment and identification of the feature is received in the first environment. The method also involves identifying a second application for editing the feature and providing the feature to that second application for editing. The method further involves receiving an edited version of the feature from the second application and incorporating the edited version into the first application in the first environment.

Another exemplary embodiment comprises a system that uses a mapping to facilitate the editing of an application's features. The exemplary system comprises a mapping of one or more features associated with running a first application to one or more sources. The system further comprises a component for running the first application and identifying a feature for editing in the first application that is running. The system also comprises a component for identifying and launching a second application for editing the feature, wherein identification of the second application comprising using the mapping to identify the second application. And, the system also comprises a component for receiving an edited version of the feature and incorporating the edited version of the feature into the first application that is running.

In other embodiments, a computer-readable medium (such as, for example, random access memory or a computer disk) comprises code for carrying out the methods and systems described herein.

These illustrative embodiments are mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present disclosure are better understood when the following Detailed Description is read with reference to the accompanying drawings, wherein:

FIG. 1 is a system diagram illustrating a content creation environment and an exemplary runtime environment, according to certain embodiments;

FIG. 2 illustrates an exemplary runtime environments providing an exemplary “select feature to edit” tool in a runtime environment, according to certain embodiments;

FIG. 3 illustrates an exemplary graphic editor provided in response to use of the exemplary “select feature to edit” tool of FIG. 2, according to certain embodiments;

FIG. 4 illustrates the exemplary runtime environment of FIG. 2 after an exemplary edit was performed through the graphic editor of FIG. 3, according to certain embodiments;

FIG. 5 is a flow chart illustrating an exemplary method of editing an application feature from a runtime environment, according to certain embodiments; and

FIG. 6 is a flow chart illustrating an exemplary method of identifying an editing application for editing a feature and providing the feature to the identified editing application for editing, according to certain embodiments.

### DETAILED DESCRIPTION OF EXEMPLARY EMBODIMENTS

Certain embodiments provide systems and methods that allow a runtime environment to access or link to an editing environment. For example, a user may run an application in a runtime environment, identify an object in the runtime environment for editing, and be provided with the appropriate editing application for editing the object. In some cases, after editing the object in the editing application, the user can return to the runtime to continue using the application in the runtime environment with the edited object inserted into the running application. The ability to link to an editing environment from within a runtime environment provides various benefits, including, as an example, facilitating testing during the application creation process.

Certain embodiments relate to allowing editing of graphical or other displayed assets of an application from a runtime environment. A user may execute an application and identify a graphical object such as a vector representation, an image, movie, animation, widget, or some displayed text. The runtime may identify an appropriate editing application and cause that application to be launched for editing the identified graphical object. For example, a user may execute a rich internet application (RIA) and notice that the logo displayed in the application has the incorrect color or size. The user then initiates editing within the runtime in some manner and is linked to the appropriate editing tool displaying the logo object for editing. After editing the logo object, the user initiates a return to the runtime and returns to the prior position within the application in the runtime environment with the revised logo object inserted.

A variety of mechanisms can be used to initiate editing of an object within a runtime environment. In certain embodiments, a selection tool is made available in the runtime environment so that when the user activates the selection tool, the user is able to select one or more assets for editing. This type of selection tool can be referred to as a “developer's hand” in the sense that it allows a user in the runtime environment to interact with or select objects that are displayed in a manner in which a developer interacts or selects objects in a creation/editing environment.

These illustrative examples are given to introduce the reader to the general subject matter discussed herein. The disclosure is not limited to these examples. The following sections describe various additional embodiments and examples of methods and systems that allow a runtime environment to access or link to an editing environment.

### Illustrative Authoring and Runtime Environments

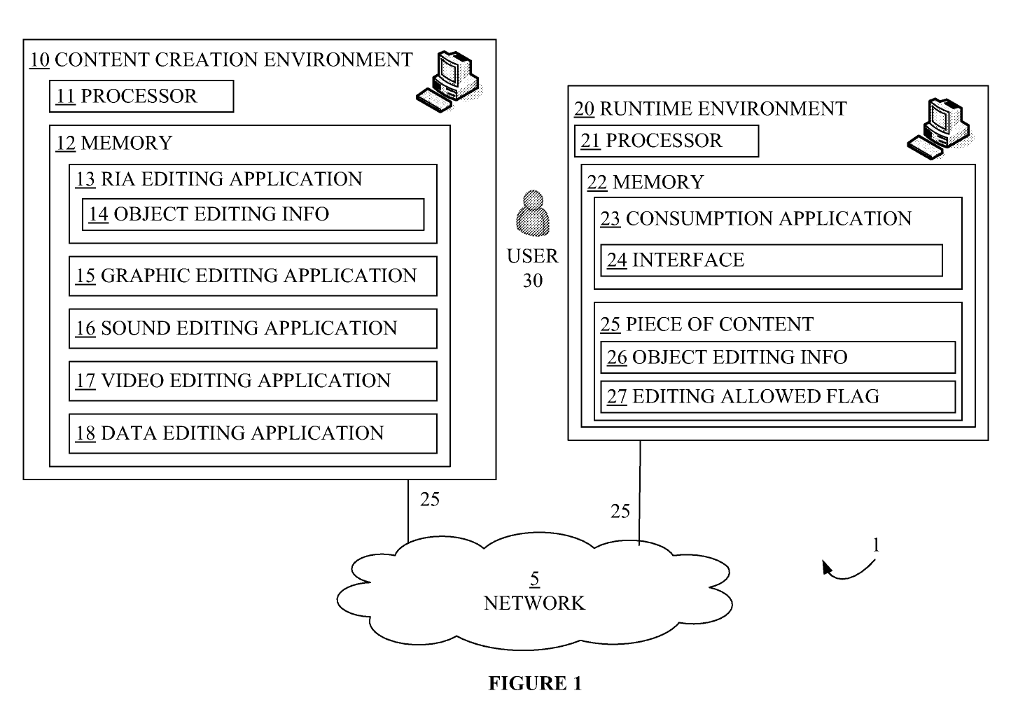

Referring now to the drawings in which like numerals indicate like elements throughout the several figures, FIG. 1 is a system diagram illustrating a content creation environment 10 and an exemplary runtime environment 20 according to certain embodiments. Other embodiments may be utilized. The system 1 shown in FIG. 1 comprises a content creation environment 10, which may, for example, include a computing device that comprises a processor 11 and a memory 12. A user 30 uses the content creation environment 10 to author an application or other content. A content creation environment 10 may include a variety of applications and features useful in creating all types of content.

To illustrate this, the exemplary content creation environment 10 of FIG. 1, includes a memory 12 comprising a RIA editing application 13, a graphic editing application 15, a sound editing application 16, a video editing application 17, and a data editing application 18. The exemplary RIA editing application 13 may utilize objects, such as graphics, sounds, videos, and data created and edited by the other applications 15, 16, 17, 18. The RIA editing application 13 may also include various design/development features, one or more canvas or display areas for positioning objects, interactivity/change definitions, and/or various other components useful in creating RIA. Components of the content creation environment 10 may reside on a single computing device or upon multiple computing devices.

A RIA editing application 13 can be used to create RIAs or other pieces of content 25 that are provided for execution or use in a runtime environment 20. The content creation environment 10 and the runtime environment 20 may reside on separate computing devices and communicate, for example, through a network 5 or otherwise. Alternatively, the content creation environment 10 and the runtime environment 20 may reside on a single computing device.

The exemplary runtime environment 20 includes a copy of the piece of content 25 for execution or use by processor 21. In the embodiment shown in FIG. 1, the runtime environment comprises a consumption application 23 in memory 22 for executing or using the piece of content 25. The consumption application 23 as illustrated includes an interface 24. Such an interface 24 may be used to identify the piece of content for execution or use. As a specific example, Adobe® Flash Player® may be used as a consumption application 23 for executing compatible applications. In alternative embodiments, an alternative consumption application or no consumption application may be used. For example, piece of content may be a stand alone application that can be executed or used directly through the operating system of other host environment.

In FIG. 1, in addition to the content itself, the exemplary piece of content 25 comprises object editing information 26 and an editing allowed flag 27. If the editing allowed flag is set to allow editing through the runtime environment 20, consumption application 23 may provide additional features during the execution or use of the piece of content 25. Specifically, during execution or use of the piece of content, the consumption application 23 may allow a user to identify one or more of the runtime objects or other runtime features for editing. As one example, the interface 24 may provide a selection tool that allows the user 30 to selection one or more objects or other features for editing.

Upon selection of such a tool or other initiation of editing of an object or feature, the consumption application 23 can link to an appropriate editing application using the object editing information 26 found within (or otherwise associated with) the piece of content 25. For example, upon receiving a selection of a particular graphics object, the consumption application 23 may identify and launch an appropriate graphic editing application to allow the user to edit the asset. After editing of the object is complete, in some embodiments, the user is able to return to the executing application to observe the edited object within the runtime environment 20.

Returning to an appropriate state of the runtime application with the edited object or feature injected can be accomplished in a variety of ways. For example, the runtime environment 20 may re-execute the application in the background and automatically navigate through the background running application to the appropriate position. In some cases, however, given an appropriate format of the content or application for example, re-executing the application in the background is not necessary and the revised object or other feature can simply be replaced within the code that is being executed. Returning to an appropriate state of the runtime application with the edited object or feature injected can be accomplished in alternative ways as will be appreciated by those of skill in this field.

### Illustration of Exemplary Editing of an Application Object or other Feature From a Runtime

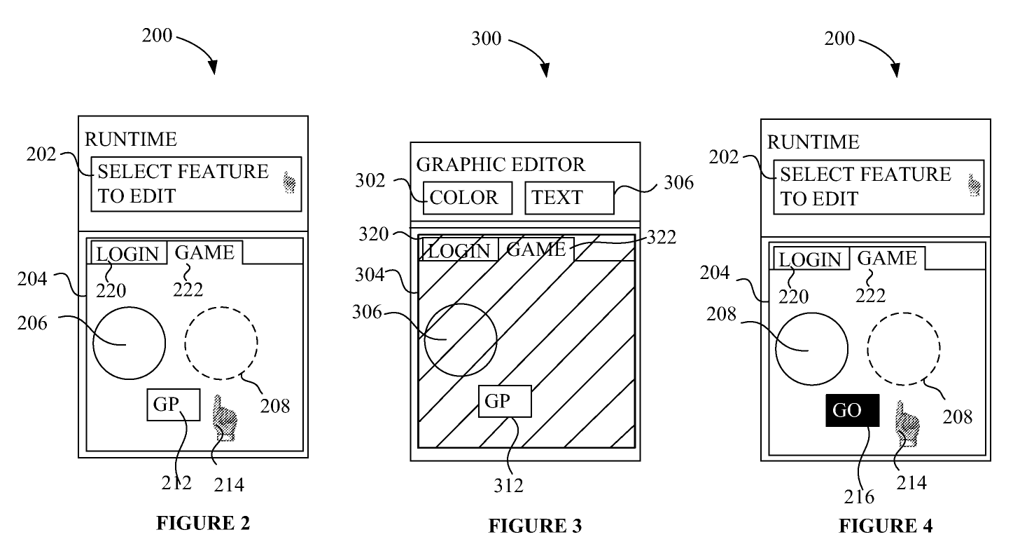

FIGS. 2-4 illustrate runtime and editing environments associated with an exemplary method of editing an application object from a runtime. FIG. 2 illustrates an exemplary runtime environment 200 providing an exemplary “select feature to edit” tool 202. FIG. 3 illustrates an exemplary graphic editor 300 provided in response to use of the exemplary “select feature to edit” tool 200 of FIG. 2. FIG. 4 illustrates the exemplary runtime environment 200 after an exemplary edit was performed using the graphic editor 300 of FIG. 3.

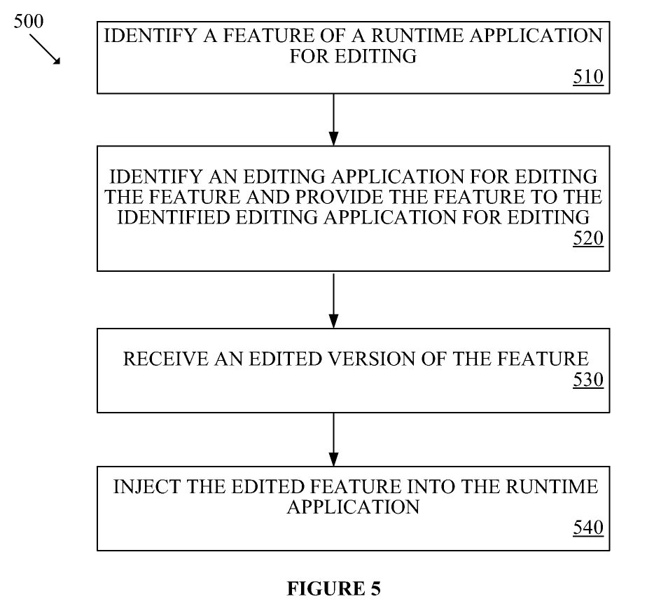

FIG. 5 is a flow chart illustrating an exemplary method 500 of editing an application feature from a runtime, according to certain embodiments. To facilitate understanding of certain features of certain embodiments, the method 500 of FIG. 5 is discussed below and certain aspects illustrated with respect to the exemplary runtime 200 and graphic editor 300 of FIGS. 2-4. Other embodiments of the exemplary method 500 of editing an application feature from a runtime are of course also possible.

The method 500 comprises identifying a feature of a runtime application for editing, as shown in block 510. An identification of a feature can be received from a user or otherwise determined. For example, referring to FIG. 2, a user may initiate the running of an application in a runtime environment 200. The running application 204 displays a login tab 220 and a game tab 222. When the game tab 222 is selected as it is in FIG. 2, the application displays various objects, including a circle 206 that moves to a new position 208 when the button 212 is mouse clicked in the runtime of the application 204. The runtime environment 200 also includes a “select feature to edit” tool 202 that allows a user of the application 204 to change the way the user is interacting with the application. Upon selection of the “select feature to edit” tool, a selection tool 214 is presented that allows the user to select one or more objects of the application 204 for editing. For example, if the user mouse clicks on the button 212, the button will be identified for editing. As another example, the user may use the selection tool to draw a box around one or more objects for editing.

Certain embodiments involve receiving a request identifying a displayed object for editing (including, but not limited to, a graphic, sound, movie, text, or image). There are a variety of ways this can be accomplished. Certain embodiments provide a selection tool while others allow a user to change the runtime mode to edit mode with a simple right mouse button click or other command. Certain embodiments, allow selection of an object's skin for editing. A “skin” can be defined as anything associated with the appearance of an object or, even more broadly, as anything other than the logic associated with an object. For example, a button object's skin may have an up state, a down state, a rollover, etc, where the button's skin defines graphics for each of these states. In many cases, a designer is concerned with editing an object's skin. Accordingly, identifying a feature of a runtime application for editing may involve requesting a particular kind of edit (as examples, a skin edit, a logic edit, a general edit, a single object edit, a multi-object edit, a state-specific edit, an associated event edit, etc.).

Generally, selection of an feature is facilitated in some embodiments through a selection tool that provides a significant amount of flexibility in allowing a user to select an object or other feature of an application for editing. For example, such a tool may allow a user to click behind one object to select another. As another example, a selection tool may facilitate selection of a graphic portion of an object such as an image rather than an associated container object. Selection may involve presenting a user with a list or hierarchy of selected objects and allow the user to narrow the selection using the list or hierarchy. For example, the user may select a button and be able to select some or all of the various components that comprise the button.

A user may be able to select an event associated with an object, such as, for example, selecting a button click event associated with an identified button object. An identified feature of a runtime application, as an example, may be an event handler associated with a particular button event, such as, for example, a button click event. As another example, to receive code relating to handling a “T” key on the keyboard, a user may enter the select feature tool and press the “T” keyboard key. In response, the application may identify and provide the event handler for that particular event for editing. This can be used, for example, when a user identifies in runtime that clicking on a button initiates playing of the wrong animation. The user is able to quickly access and correct the associated event handling. Generally, in addition to displayed objects, other features of an application or content may also be identified for editing, providing a variety of additional benefits to certain embodiments.

In the example shown in FIG. 2, a user selects the “select feature to edit tool” 202 and uses selection tool 214 to select the graphic of the button 212. In this case, that graphic includes the text “GP,” in black font on a white background. This is merely an example of one type of identification of a feature of an application or content. A variety of alternatives may of course be used.

For example, another embodiment involves launching an application in a specific type of runtime mode, such as, for example, a runtime mode in which commands are treated as user commands unless the control key is depressed when the command is received. In this example, if the user mouse clicks on a button without the control key depressed the application responds in its runtime manner, but, if the control key is depressed when the mouse click on the button occurs, the runtime environment may initiate editing of the identified button.

The method 500 comprises identifying an editing application for editing the feature and providing the feature to the identified editing application for editing, as shown in block 520. In some cases, this is simply a matter of identifying the application used to create the application. For example, if the application is an RIA, the RIA creation application may be used to edit an object of the RIA. However, in some cases, an RIA or other content may involve objects incorporated from other editing applications. For example, an RIA may include an image object or a sound object. Similarly, a particular object of an RIA may include a component created on another application. For example, a button object may include an image created on an image editing application separate from the RIA editing application used to create the RIA. In addition to providing the feature to be edited, the method may involve providing context information from the runtime application thus allowing the editing application to configure and/or display other objects so that the editing environment appears similar to the runtime. In some cases, this may involve synchronizing the state of the editing application to match the state of the runtime.

Providing the feature to the identified editing application for editing may involve configuring or providing information to an editing tool for editing the feature of the application. For example, an image editing application, such as Adobe® Photoshop®, may be launched to present an identified image object for editing. As another example, a sound editing application may be launched to allow an identified sound object to be edited. In addition, other features that are not being edited and/or state information for one or more objects may also be provided to provide context for the edit.

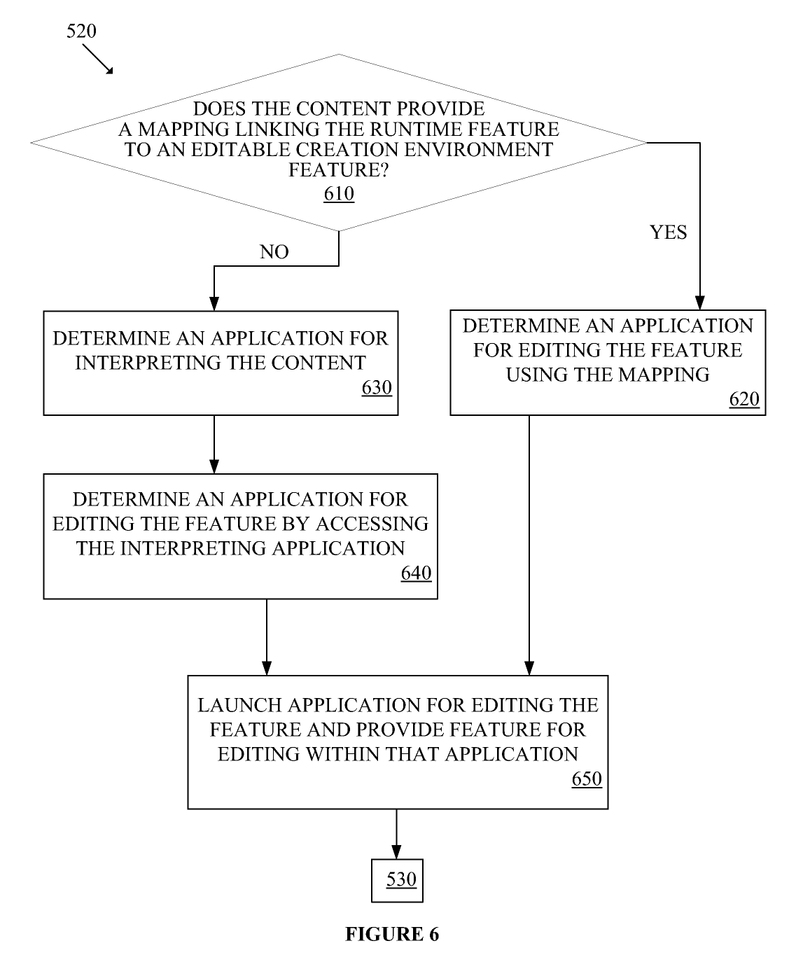

FIG. 6 provides an exemplary method of performing the step 520 identifying an editing application for editing the feature and providing the feature to the identified editing application for editing. Generally, objects in a running application may correspond to multiple components during the application's creation. Several files and/or graphic assets in the editing environment may correspond to one object at runtime. For example, a skin may make use of several images and some programmatic drawing for defining each of its several states. A mapping from runtime objects to creation application objects may be used to facilitate identifying an editing application and provide the feature to the identified editing application for editing.

The exemplary method 600 comprises determining whether the content itself provides a mapping linking the runtime feature to an editable creation environment feature, as shown in block 610. Such a mapping may be useful, among other contexts, in the context of an RIA application that includes components created in one or more other editing applications. For example, for a selected image object of an RIA application, a mapping may be used to identify a photo editing application to edit the selected image object. The mapping may, for example, identify the source or format of the object. In the case of a component, widget, or other object the source may be more complex or it may be several files or sets of files. The source, for example, may include some graphics and some descriptive and/or other code. Such a mapping can be stored as part of the content or application as data, code, metadata or in any other form. One exemplary mapping involves an RIA or other application including symbols, which are extra information that relates one or more sources to the binary formatted information of the application. As another example, an application or content may contain a unique identifier or other attribute that is used to access a mapping from another location.

If the content does provide (directly or indirectly) a mapping linking the runtime feature to an editable creation environment feature, the method 520 proceeds to block 620 to determine, using the mapping, an application to use for editing the feature. In some cases, the mapping itself may directly identify an appropriate editing application for example, the mapping may identify that Adobe® Photoshop® should be used to edit a given object. In other cases, the method may involve determining an appropriate editing application in other ways. For example, if the object is a file, the object's file type, format, or extension may be examined to identify an appropriate editing application. In some cases, the applications that are available for editing either locally on the users device or through a remote application provider are considered in determining an appropriate editing application. If an appropriate editing application is not available, the method may involve presenting the user with an option to obtain one, for example, via download. In addition, user preferences may be accounted for. If, for example, the user preferences indicate that a user has a favorite application for editing image files, this can be used in determining an appropriate editing application.

If the content does not provide a mapping linking the runtime feature to an editable creation environment feature, the method 520 proceeds to block 630 to determine an application for interpreting the content. For example, in the context of an RIA application, an appropriate RIA application may be identified to act as an intermediary or source of information useful in determining an appropriate editing application for a particular component object within the RIA application.

Thus, in block 640, method 520 determines an application for editing the feature by accessing the interpreting application. In the RIA context, an RIA editing application can provide the function of a mapping by identifying a particular editable version of the identified object and linking to or identifying the editing application on which that asset was created and/or can be edited. An RIA editing application can act as an intermediate communicator between a runtime and specific object editing application. For example, the runtime of an executing Flash® formatted application may link to a copy of Adobe® Flash® Professional to determine that a particular object selected in the runtime corresponds to a image file stored in a particular file directory on the user's local computer and that the image was created (and thus can be edited using) Adobe® Photoshop®. In some embodiments, the image that is edited may be the actual image from the running application. Thus, it is not always necessary to determine a corresponding or source asset to edit where the embedded asset is available for editing. Some embodiments provide a user an option of editing a runtime object directly or editing a corresponding source object.

An application for interpreting the content or other intermediary does not need to be a creation application. For example, certain embodiments provide a specific tool or application that provides the function of inspecting a runtime version of an application or other content and determining a mapping associating a runtime feature with an editable creation environment feature. For example, the interpreting application may identify a selected runtime object and use that object to find or identify a corresponding source object.

Once an application for editing the feature has been determined using a mapping in either block 620, block 640, or otherwise, the method 520 proceeds to launch the identified application for editing the feature and provides the editable object, as shown in block 650. For example, the source object may be provided within the identified editing application for editing. The user is thus directly linked to an interface from the runtime that allows editing of one or more identified features of the running application.

An editing application for editing a feature may be an RIA application or other application capable of using objects of various types. For example, an RIA application may be used to edit the positions of multiple objects displayed in a runtime application. As a specific example, an RIA may use an expandable palette widget, a button, and a list. All of these objects may be identified for editing, and the RIA editing application may be provided to allow the user to edit the positions and other editable aspects of these RIA objects.

Editing objects having multiple states is also possible. For example, in a runtime RIA application having several states: S1 (login), S2 (store), S3 (checkout), an editing application may be accessed for editing a particular identified state. Thus, a user may test the runtime application, navigating through the various states of the running application. In doing so, the user may identify a problem with a cart image used in the checkout state, and use a “select feature to edit” tool to select this cart image and initiate editing of it in an appropriate image editing application.

In addition, the user may more generally link back to the application used to edit the RIA application and edit additional attributes associated with the cart image. In doing so, the RIA editing application may be launched and present the appropriate state of the RIA for editing, which, in this case is the checkout state. This can be facilitated in a variety of ways. In some cases, the editing state is identified based on a runtime state, attempting to allow editing of the editing state closest to the current runtime state. The state, at runtime, may be determined using the mapping discussed above or in any other suitable way. A “state” in this context simply refers to a portion of an application that is identifiable and differs from another portion of the application. Typically, given a particular state, the application and its objects will have a specified static or non-static appearance. States are often used in development is to break up an application into pieces and, in some cases, can provide some or all of a mapping usable to identify a feature and/or editing application.

With respect to editing, in some case only a selected object is presented in a specific state for editing. In alternative embodiments, the entire creation environment associated with the state of the selected asset is presented for editing. In some applications, an application may have a state different from the state or states associated with particular components within the application. Because the application and its component objects can each be associated with one or more states, a variety of combinations are possible. For example, an application may be in a checkout state and a particular button object displayed in the checkout state may also be in a mouse-hover state. If an RIA application is provided for editing the mouse-hover state of the button it may also provide the application's checkout state to provide appropriate context for the editing.

Certain embodiments do not involve editing graphical objects. For example, certain embodiments facilitate a program code developer work flow by allowing a developer to identify and edit an appropriate set of files for an identified portion of an application. In some contexts, such a developer is able to link to edit code associated with one or more selected graphical objects or any other feature of a runtime application or content.

In a runtime application, a mapping may be used to identify the source of data that appears or is otherwise used. Applications and other content can retrieve data from servers, databases, and other sources. For example, assets of a runtime application may be pulled from a database based on a specified query. A mapping used to facilitate linking to an editing application from a runtime may identify a data source and allows editing of the data. In some cases, the database contains files and other object assets, such as, for example, an image file that is stored in a database and used to display an image in the running application. As another example, a runtime application may display a data grid of customer names and pictures. Upon selection of a “select feature for editing” tool, a runtime application may facilitate identification that an identified object, such as a customer image, came from a database (rather than from within the application file itself or elsewhere). The runtime application may further retrieve the object and launch an appropriate editing application.

In some embodiments, a runtime application will include a runtime version of an object that is associated (for example, developed from) a source object that is stored on a database. During runtime, if the runtime object is selected for editing, the location of the source object is identified and the source object is received for editing, re-storage, and update of the runtime application. In some embodiments, a mapping comprises a complete copy of source objects is stored within the runtime application itself.

After launching the application for editing the feature and providing the feature for editing within that application, shown in block 640, the method 600 may involve receiving one or more edits to the feature.

FIG. 3 illustrates an exemplary graphics editor application 300 provided for editing the identified button 212 of FIG. 2. For ease of explanation, the exemplary graphic editor 300 includes a color tool 302 for changing an objects color, a text tool 306 for changing an objects color, and an editing canvas 304 area for displaying the graphical object that is being edited. Obviously, graphic editor applications and other editor applications used to edit the attributes of a feature of an application can and typically will have various other tools, aspects, and differing levels of sophistication.

In this example, the graphic editor 300 provides an editable version 312 of the button 212. The user can, for example, use the color tool 302 and text tool 306 to change the button's background color to black, the button's text color to white, and the button's text from “GP” to “GO.” In addition, the graphic editor has received context information potentially useful in editing the button 212. In this case, graphical elements 304, 306, 320, 322 are displayed in the graphical editor 300 to provide context for the user making the edit. For example, in this case the user is able to see that the button 212 is part of the game tab 222 because of the displayed game tab 322. In this example, the graphical elements 304, 306, 320, 322 that are provided for context cannot be edited. The graphical elements may be grayed out, lined through, or otherwise differentiated from the one or more components that can be edited within the graphic editor application 300.

An editing environment can use context information in a variety of ways. In one embodiment an editing environment can configure all the components around the object being editing so that each component is in the same state as it was in the runtime environment. In another embodiment there is an editing environment that does not necessarily understand some or all of the runtime components or states. A proxy object or objects can be used to represent such non-native objects (that is, those that are not able to be interpreted by and/or displayed in the editing environment). For example, where the context information identifies objects that are not native to the editing environment, the editing environment can determine proxy objects using the context information and display the proxy objects in place of the non-native objects. A proxy object could be, as examples, an image, movie, vector, of some other form that is native to the editing environment. The proxy object can be created from the context information so that the editing environment appears the same as the runtime environment.

After receiving any edits from an editing application, the method 600 returns to block 530 of FIG. 5 which involves receiving an editing version of the feature. For example, the graphics editor application 300 of FIG. 3 may be opened with the instruction that upon closing or saving, the graphics editor application 300 is to send a copy of the edited object or feature to the runtime environment 200.

As shown in block 540, upon receiving an updated object or other feature, the method 500 involves injecting the edited feature into the runtime application. This may involve pausing the runtime application, revising, some or all of the code of the application, and allowing the application to continue. In some cases, the application may need to begin from its beginning. In such cases, the runtime application may automatically navigate the application (with or without displaying such navigation) to the location within the runtime of application at which the user initiated the editing of the feature.

In FIG. 4, the edited button is 216 is displayed in place of the prior version of the button 212. In this case, the background color of the button 216 has been changed to black, the text color of the button 216 has been changed to white, and the text of the button 216 has been changed from “GP” to “GO.” The runtime application (after conclusion of the use of the “select feature to edit” tool 202) returns to its previous normal runtime status, in which the user can interact with and otherwise use the running application as in runtime mode, for example, using the runtime mouse cursor 218. Obviously, the user can subsequently switch back and forth between the “select feature to edit” tool 202 and the normal runtime mode. Thus, generally, certain embodiments provide a convenient runtime-based workflow for a user to test and edit an application or other content.

### General

Numerous specific details are set forth herein to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing platform, such as one or more computers or a similar electronic computing device or devices, that manipulate or transform data represented as physical electronic or magnetic quantities within memories, registers, or other information storage devices, transmission devices, or display devices of the computing platform.

Certain embodiments provide techniques for provide a gesture in the runtime of the application that calls back to a design application. These embodiments are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown in FIG. 1 as functional or storage components on the respective devices. As is known to one of skill in the art, such applications may be resident in any suitable computer-readable medium and execute on any suitable processor. For example, the devices each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, ActionScript, MXML, and JavaScript.

While the network shown in FIG. 1 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs. The server devices may be single computer systems or may be implemented as a network of computers or processors. Examples of a server device are servers, mainframe computers, networked computers, a processor-based device, and similar types of systems and devices.

What is claimed is:

1. A computer implemented method comprising:
identifying, by an editing application executed by a processor, a feature of a runtime version of a first application for editing in response to receiving a selection of the feature, wherein the feature is a part of the first application running in a runtime environment and the selection of the feature is received in the runtime environment;
identifying, by the editing application, a second application for editing the feature in response to identifying the feature in the runtime version of the first application, wherein the second application is identified using a mapping accessible via the first application;
providing, by the editing application, the feature to the second application; and
receiving, by the editing application, an edited version of the feature from the second application and incorporating the edited version of the feature into the first application that is running in the runtime environment.

2. (canceled)

3. The method of claim 1, wherein identifying the feature comprises receiving a selection of an option to change subsequent interaction with the first application such that the subsequent interaction identifies the feature.

4. The method of claim 1, wherein identifying the feature comprises receiving an option requesting an edit, the edit having a selected type.

5. The method of claim 4, wherein the selected type of the edit comprises an edit to the skin of an object.

6. The method of claim 4, wherein the selected type of the edit comprises an edit to an event associated with the feature of the first application.

7. The method of claim 1, wherein the feature comprises an object, state, or event of the runtime application.

8. The method of claim 7, wherein the feature comprises the object and the object comprising a graphic, a sound, a movie, or a text.

9. The method of claim 7, wherein the feature comprises a plurality of objects.

10. The method of claim 1, wherein identifying the feature comprises receiving an identification of at least one selected aspect of the first application, providing a list or hierarchy of the at least one selected aspect, and receiving a selection of a subset of the at least one selected aspect as the feature.

11. The method of claim 1, wherein the first application is capable of running in a first mode in which the feature can be identified and edited and a second mode in which interaction is received as normal user interaction.

12. The method of claim 1, wherein identifying the second application comprises identifying an application used to create the first application.

13. The method of claim 1, wherein providing the feature to the second application comprises launching the second application and causing the second application to provide the feature for editing.

14. The method of claim 1, further comprising pausing execution of the first application in the runtime environment at a state of the first application in response to identifying the feature in the runtime environment,
wherein incorporating the edited version into the first application in the runtime environment comprises, revising code implanting the feature in the first application resuming the execution of the first application from the state in response to an indication that revision of the code implementing the feature is complete.

15. The method of claim 1, further comprising pausing execution of the first application in the runtime environment in response to identifying the feature in the runtime environment,
wherein incorporating the edited version into the first application in the runtime environment comprises:
revising code implementing the feature in the first application,
resuming execution of the first application in response to an indication that revision of the code implementing the feature is complete, and
advancing the running of the first application to a state other than an initial state of the first application in the runtime environment.

16. A system comprising:
a processor; and
a non-transitory computer-readable medium in communication with the processor, wherein the process is configured for executing instructions stored in the non-transitory computer-readable medium to perform operations comprising:
identifying a feature of a runtime version of a first application for editing in response to receiving a selection of the feature, wherein the feature is a part of the first application running in a runtime environment and the selection of the feature is received in the runtime environment,
identifying and launching a second application for editing the feature responsive to identifying the feature in the runtime version of the first application, wherein the second application is identified using a mapping accessible via the first application,
providing the feature to the second application, and
receiving an edited version of the feature from the second application and incorporating the edited version of the feature into the first application that is running in the runtime environment.

17. The system of claim 16, further comprising pausing execution of the first application in the runtime environment at a state of the first application in response to identifying the feature in the runtime environment,
wherein incorporating the edited version of the feature comprises:
revising code implementing the feature in the first application at the state of the first application, and
resuming the execution of the first application in response to an indication that revision of the code implementing the feature is complete.

18. The system of claim 17, wherein the mapping identifies a location of a copy of at least one source object corresponding to the feature identified in the runtime environment, wherein providing the feature to the second application comprises providing the copy of the at least one source object to the second application.

19. The system of claim 16, wherein the mapping comprises an identification of a format of the feature and the format of the feature is used to identify the second application.

20. The system of claim 16, wherein the mapping comprises an identification of the second application.

21-22. (canceled)

23. The system of claim 16, wherein the operations comprising operations further comprise identifying a state of the first application that is running and determining a state for editing the feature in the second application.

24. The system of claim 23, wherein the state for editing the feature in the second application is determined using the state of the first application that is running and the mapping.

25. The system of claim 16, wherein a source of the mapping comprises a source of data used in the first application.

26. A computer implemented method comprising:
responsive to receiving a selection of a feature in a runtime version of a first application, identifying, by an editing application executed by a processor, the feature for editing, wherein the feature is a part of the first application running in a runtime environment and the selection of the feature is received in the runtime environment;
responsive to identifying the feature in the runtime version of the first application, providing, by the editing application, the feature to a second application for editing;
providing, by the editing application, context information to the second application for replicating an appearance or behavior of the feature at runtime, the context information associated with the use of the feature by the first application running in the runtime environment; and
receiving, by the editing application, an edited version of the feature from the second application and incorporating the edited version into the first application in the runtime environment.

27. (canceled)

28. The method of claim 26, wherein providing the context information comprises:
responsive to identifying the feature in the runtime version of the first application, identifying a state of the feature in the first application; and
providing the state as the context information.

29. The method of claim 26, wherein providing the context information comprises:
responsive to identifying the feature in the runtime version of the first application, identifying a state of at least one additional feature in the first application associated with the feature identified in the first application; and
providing the state as the context information.

30. The method of claim 26, wherein providing the context information comprises:
responsive to identifying the feature in the runtime version of the first application, identifying a state of the first application running in the runtime environment; and
providing the state as the context information, wherein the state is usable to configure the second application to present the state of the first application for editing the feature in the second application.

31. The method of claim 26, wherein the context information identifies at least one object associated with the feature in the first application, and further comprising:
determining that the at least one objected cannot be displayed by the second application or interpreted by the second application; and
selecting at least one proxy object using the context information; and
displaying or interpreting the at least one proxy object in place of the at least one object identified in the context information.

32. The method of claim 31, wherein the at least one proxy object proxy objects comprises an image in a format that can be displayed or interpreted by the second application, the image having an appearance similar to the appearance of the at least one object identified in the context information.

33. A non-transitory computer-readable medium on which is encoded program code, the program code comprising:
program code for identifying a feature of a runtime version of a first application for editing responsive to receiving a selection of the feature, wherein the feature is a part of the first application running in a runtime environment and identification the selection of the feature is received in the runtime environment;
program code for identifying a second application for editing the feature responsive to identifying the feature in the runtime version of the first application, wherein the second application is identified using a mapping accessible via the first application;
program code for providing the feature to the second application for editing; and
program code for receiving an edited version of the feature from the second application and incorporating the edited version into the first application that is running in the first runtime environment.

34. (canceled)

35. The method of claim 1, wherein identifying the second application via the mapping comprises:
identifying a format of an object in the feature selected for editing; and
determining that the format of the object is mapped to the second application via the mapping.

36. The method of claim 1, wherein identifying the second application via the mapping comprises:
identifying a format of an object in the feature selected for editing; and
identifying a plurality of editing applications configured for editing objects having the format;
determining that the second application is a preferred one of the plurality of applications for editing the object.

37. The method of claim 1, wherein identifying the second application via the mapping comprises:
identifying a location of the mapping from an identifier included in the metadata of the first application; and
accessing the mapping via the location.

38. The method of claim 1, wherein the mapping is stored in metadata for the first application.

39. The method of claim 1, wherein the feature has a plurality of states and wherein providing the feature to the second application comprises:
identifying a current state from the plurality of states for the feature; and
providing the feature in the current state to the second application.
